(19) United States
(12) Patent Application Publication
(10) Pub. No.: US 2009/0048127 A1
(43) Pub. Date: Feb. 19, 2009

(54) BODY-IN-WHITE STAMPING LUBRICANT WITH ANTI-WELD SPATTER PROPERTIES AND RELATED PROCESSES

(75) Inventor: Katherine Helmetag, Troy, MI (US)

Correspondence Address: HENKEL CORPORATION, 1001 TROUT BROOK CROSSING, ROCKY HILL, CT, 06067, US

(73) Assignee: Henkel KGaA, Duesseldorf (DE)

(21) Appl. No.: 12/191,350

(22) Filed: Aug. 14, 2008

Related U.S. Application Data
(60) Provisional application No. 60/955,728, filed on Aug. 14, 2007.

(51) Int. Cl. C10M 169/04; B23K 33/00

(52) U.S. Cl. 508/100; 219/137 R

(57) ABSTRACT

A method of making an article of manufacture comprising applying an anti-weld spatter lubricant composition to a first weldable metal substrate to produce a coated metal substrate; forming the coated metal substrate into a coated formed part; and welding together the coated formed part and a second weldable substrate to form a welded construction, characterized in that no anti-weld spatter compositions are applied between the forming and welding steps and an article of manufacture comprising a welded construction having at least one formed metal surface and a layer of anti-weld spatter lubricant composition on and in direct contact with said formed metal surface, in the absence of a forming lubricant layer interposed between said formed metal surface and the layer of anti-weld spatter lubricant composition.

### CROSS-REFERENCE TO RELATED CASES

This application is a continuation of and claims priority to U.S. Provisional Patent Application Ser. No. 60/955,728 filed Aug. 14, 2007 hereby incorporated herein by reference in its entirety.

### FIELD OF THE INVENTION

This invention relates to processes of forming and welding sheet metal having fewer process steps by use of a metalworking composition for forming, e.g. stamping, sheet metal into parts that provides the added benefit of reducing weld spatter related flaws on the formed part, when it is subjected to welding. Residual material from the metalworking composition remaining after the forming operation provides a coating with anti-weld spatter properties. More particularly, the invention relates to methods of treating a metal substrate with dual-purpose compositions useful in metalworking and welding, methods of making and methods of applying these compositions, and methods of removing weld spatter as well as articles of manufacture comprising coatings of these compositions, before and after forming and/or welding.

### BACKGROUND OF THE INVENTION

A variety of products, such as for example automobile bodies and components, agricultural and construction vehicles, recreational vehicles, heating and air conditioning units, machinery and equipment housings, as well as furniture and appliances, are assembled of parts that are stamped from coiled or cut metal sheet. The parts are often joined together by welding to form a unitized construction or are welded to a frame to form a single structure. Many of these applications require a uniform show surface, that is, the formed, welded and often painted surface is desired to provide a uniform appearance without bumps, adhered weld beads, unpainted spots or other paint flaws or inclusions. This is particularly important in the consumer automobile industry. One example of such a process is, the process to produce an automotive “body-in-white” (BIW), the manufacturing stage where auto body sheet metal has been assembled, but trim and other components have not been added. This process starts with the stamping of steel or aluminum sheets into the shapes required to form apertures (sides of the car), roofs, doors, and other Class A and Class B surfaces; these shapes are then welded together to form a car body assembly. Class A and Class B surfaces are those surfaces meeting particular criteria for uniform surface appearance, such as exterior metal surfaces of a vehicle having requirements for aesthetic appeal.

Prior to forming, metal substrates are conventionally coated with lubricants to facilitate the forming process. Generally, a mill oil or “body-in-white” forming compound is used to lubricate the metal prior to the forming operation (e.g. stamping). The stamping lubricants used, particularly for body-in-white panels and parts, are generally the least expensive mill oils that are available. These materials are generally screened for cleanability and forming performance prior to use. The residues from the lubricant, which are present on the parts after stamping, are typically comprised of oxidized and degraded oils that can be difficult to remove and may age to uncleanable materials if left on the formed metal panel for very long, which is a drawback of the conventional forming lubricant.

A drawback of conventional processing is that the stamping process is frequently evaluated for cost without considering the entire product assembly process or the needs of the assembly shop (e.g. welding suitability) and/or a subsequent paint line. The result is often mill oil choices that negatively impact production and incur extensive cleaning of the formed part prior to welding and/or painting, as well as other costs. A particular drawback of conventional mill oils is their tendency to oxidize during or after forming and difficulties in removing the mill oil or residues thereof.

In conventional processes, sheet metal used to form parts is coated with mill oil or stamping compound and sent to the press for fabrication. The mill oil or stamping compound remains on the part and acts as a rust preventive for the parts while in transit to the assembly plant and through the assembly process. After the metal is formed into parts, the bodies or components may be stored or shipped prior to the assembly process. Assembly consists of arranging the formed panels or parts in an appropriate manner for joining to each other or a frame, and then welding, such as spot resistance welding, the panels or parts into place. The resistance spot welding method uses electrical current and voltage to fuse the pieces of metal together. The welding tips must contact the parts with the correct surface area and angle of attack to produce a good quality and clean weld.

Both the stamping process and the spot welding process are the source of many problems in subsequent painting steps. The mill oil and mill oil by-products, as well as remnants from welding, remaining on formed parts can interfere with paint adhesion and coverage. Conventionally, prior to welding, the formed part is subjected to a cleaning step trying to remove at least some of the mill oil and an application step where a conventional anti-weld spatter composition is applied. Alternatively, the mill oil or residue thereof is left in place and the anti-weld spatter composition is applied on top of this layer. In either process, the metal must eventually be cleaned of the mill oil prior to painting.

Welding generates a pool of molten metal from the substrates to be welded. During the welding process, waste material is thrown off the metal surface at or near this area of molten metal and deposits or redeposits on nearby areas of the metal panel or part being welded. The waste material is typically metal, possibly with some contaminants such as oxides, and is known in the industry as “weld spatter”. These small particles of metal are generally roughly spherical in shape and are observed as sparks flying from the welded spot during the welding operation. The weld spatter can present as small “BBs” on the panel or part surface. Weld area cleanliness is marked by the absence of “BBs” or weld spatter. Weld spatter is considered undesirable as negatively impacting aesthetics, as well as being a location where corrosion can start.

The weld spatters (e.g. BBs) are molten as they leave the metal surface and if they redeposit while still in the molten form or at elevated temperature within about 50, 25, 20, 15, 10, 5, 1% of the melting point of the metal surface or at least a portion of the BB, then BBs can permanently adhere (stick) to the metal surface. The melting point of most steels is about 2000° F. (1093.3° C.) and weld spatter from steel welding will adhere at temperatures as low as about 1500° F. (815.5° C.). Likewise, the melting point of most aluminum alloys is about 1200° F. (649° C.) and weld spatter from aluminum welding will adhere at temperatures as low as about 600° F. (315.5° C.). Once permanently adhered (stuck) to the surface, they form metal defects that show up as paint non-uniformities, bare spots or other paint defects. Generally, all weld spatter that contacts a bare metal surface of the substrate being welded becomes permanently adhered to that surface provided that the weld spatter is at a temperature as described above, or at least about 25% of the aforementioned melting points.

The phosphate, electrocoat, and paint processes are all negatively affected by weld spatter remaining on the surface of metal substrates. One problem is failure to coat; another problem caused by weld spatter is surface defects visible through the coating deposited, such as by way of non-limiting example bumps, adhered BBs or paint inclusions.

Permanently adhered weld spatter is very difficult to remove. A conventional solution to weld spatter on metal substrates has been a costly process of grinding or sanding the adhered weld spatter prior to the phosphate and painting processes. The paint shop is deeply concerned with the permanent adherence (sticking) of weld spatter. Each “BB” that permanently adheres to the metal substrate must be ground down to the surface of the sheet metal. This requires significant hand work by the surfacing operators. Occasionally, parts and panels having weld spatter are phosphated and/or painted without prior removal of the weld spatter, which can then require reworking of the phosphated and/or painted panel or part at additional cost.

Chemical removal of permanently adhered weld spatter has been unsuccessfully attempted using acid and alkaline cleaners, metal pretreatments, zinc phosphating baths and pickling baths. Weld spatter typically has some oxidation on its exterior surface that makes it less subject to chemical attack than the surrounding metal surface, which results in too severe of a loss of metal substrate to achieve removal of the permanently adhered weld spatter chemically. Also, in many cases, a defect is left on the metal surface where the weld spatter was chemically removed which then requires physical removal by grinding or sanding.

Another known means attempting to reduce weld spatter flaws has been coating the formed panel or part with materials that reduce the adherence of the weld spatter. Weld spatter that lands on a metal surface but temporarily adheres, and does not permanently adhere (stick), to the metal surface can sometimes be cleaned off in the pre-paint or pre-phosphating cleaning process. Temporary adherence is achieved by coating the metal to be welded with compositions that interfere with the adherence of the weld spatter to the substrate, either completely or sufficiently to weaken adherence such that the weld spatter can be removed without sanding or grinding. Conventionally anti-weld spatter materials are applied just prior to welding to reduce the tendency of the weld spatter to permanently adhere (stick) to the metal surface and allow the weld spatter to be removed during the cleaning stage of the phosphate process. To be effective, in conventional processes, anti-weld spatter materials had to wet the panel or part surface over any remaining stamping lubricant and uniformly coat the metal surface. The conventional anti-weld spatter materials were also required to be easily cleaned and preferably enhanced the cleanability of the stamping lubricant. For examples of anti-weld spatter materials see U.S. Pat. No. 4,300,142, incorporated herein by reference to the extent that it does not conflict with specific recitations of this disclosure

A drawback of these conventional anti-weld spatter materials is the additional steps required for removal of the forming lubricant coating and application of the anti-weld spatter material, which increased time, raw material and equipment requirements for the process. Also, anti-weld spatter materials typically have a slippery liquid nature, which causes clean-up and slip-and-fall risks at the point-of-application of the anti-weld spatter (AWS) material and along the conveyor lengths where the material is dewatered. Thus there is a need to improve the processes of forming and welding sheet metal that solves at least some of the problems of the prior art.

It is an object of this invention to provide a composition that provides lubrication during a forming step and reduces, preferably prevents, adherence of weld spatters during a subsequent welding step, and a new process for forming and welding sheet metal that does not require removal of forming lubricant and/or application of an anti-weld spatter composition between forming and welding steps. It is also an object of the invention to provide a process which includes the step of removing weld spatter by rinsing, wiping, cleaning, pickling, pre-phosphating conditioner, phosphating, and/or non-phosphate chemical pre-treatment.

### SUMMARY OF THE INVENTION

It is an object of the invention to provide a method of making an article of manufacture comprising, preferably consisting of:
a) applying an anti-weld spatter lubricant composition to a first weldable metal substrate, and optionally drying the composition, to produce a coated metal substrate;
b) forming the coated metal substrate into a coated formed part; and c) welding together the coated formed part and a second weldable substrate to form a welded construction;
wherein substantially no anti-weld spatter compositions are applied between the forming and welding steps. By stating “substantially no”, Applicant means that minor patching or touch-up applications of anti-weld spatter compositions after forming to repair bare spots on the metal after forming. For example, such small touch-up applications may be necessary in the industrial setting where portions of the anti-weld spatter lubricant composition applied in step a) have been lost during forming.

It is a further object of the invention to provide an additional method step d) of removing any temporarily adhered weld spatter from the welded construction in the absence of sanding, chiseling and/or grinding. In preferred embodiments, the temporarily adhered weld spatter is removed by at least one of the following steps: wiping, rinsing, alkaline cleaning, acid cleaning, pickling, pre-phosphate conditioning, phosphating, and non-phosphate chemical pre-treating.

It is a further object of the invention to provide an additional method step comprising selecting a dual purpose composition for use as the anti-weld spatter lubricant composition. Desirably, the dual purpose composition is selected such that sufficient lubrication in step b) and sufficient interference with permanent adhesion of weld spatter in step c) is provided by said dual purpose composition.

It is a further object of the invention to provide a method wherein the anti-weld spatter lubricant composition and/or derivatives thereof generated in step b) remaining on said coated formed part interfere with permanent adhesion of weld spatter generated in step c).

It is a further object of the invention to provide a method wherein the second weldable substrate also comprises the coating of step a).

It is a further object of the invention to provide a method wherein the anti-weld spatter lubricant composition is applied to the metal substrate in an amount of less than 20 g/m², preferably less than 17 g/m², most preferably less than 12 g/m². Independently, it is also an object of the invention to provide a method wherein the anti-weld spatter lubricant composition is applied to the metal substrate in an amount of at least 0.5 g/m², preferably 2 g/m², most preferably at least 5 g/m².

In one embodiment, the amount of the composition applied ranges from about 2 g/m² to about 15 g/m².

It is a further object of the invention to provide a method further comprising at least one additional step of applying paint to the welded construction.

It is an object of the invention to provide an article of manufacture made according to a method disclosed herein.

It is also an object of the invention to provide an article of manufacture comprising a welded construction having at least one formed metal surface and a layer of anti-weld spatter lubricant composition on and in direct contact with said formed metal surface, in the absence of a forming lubricant layer interposed between said formed metal surface and the layer of anti-weld spatter lubricant composition. In one embodiment the anti-weld spatter lubricant composition comprises: an organic basestock comprising at least one of mineral oils, fatty esters, polyalkylene glycols, and polyalphaolefins; one or more surfactants having an inverse wetting profile; and optionally alkaline materials, viscosity-modifiers and additional adjuvants. In another embodiment, the anti-weld spatter lubricant composition comprises: at least one polyalkylene glycol; at least one surfactant having an inverse wetting profile; at least one alkaline material; and optionally, at least one of defoamers and thickeners.

### BRIEF DESCRIPTION OF THE DRAWINGS

FIG. 1 shows a comparison of the friction force recorded over a draw stroke of a standard drawbench when using a prior art metal stamping lubricant (DRAWCO® FB 27 MH) as compared to Example 1 (AWS 104). The units of “Force” on the y-axis are y*2000 pounds (drawbench readout times 2000 pounds load). Distance units “LVDT” on the x-axis are x*2 cm (drawbench readout times 2 centimeters).

### DESCRIPTION OF THE INVENTION

An improved forming and stamping process and a novel dual purpose lubricant composition, which is applied prior to forming and provides both lubrication for forming and reduces weld spatter flaws, are described herein for use in forming processes which are followed by a welding process, as well as other processes related thereto. Those of skill in the art will understand “forming” to mean operations whereby a metal substrate is permanently deformed by applying force to one or more surfaces of the metal substrate; non-limiting examples include stamping, blanking, pressing, punching, ironing and the like.

In a manufacturing process according to the invention, an anti-weld spatter lubricant composition is applied prior to forming the sheet metal creating a lubricating coating on the sheet metal. The sheet metal coated with the composition is used in forming operations such as stamping parts; that is, the coated sheet metal is subjected to a forming operation. The lubricating coating, or a derivative thereof generated during forming, is allowed to remain on the formed metal sheet during welding of the formed metal sheet. The formed metal sheets, e.g. the parts, retain the coating and proceed to assembly, where the coating reduces permanently adherent weld spatter.

An object of this invention is to provide a composition that has stamping compound performance and anti-weld spatter compound (AWS) performance, comprising water, a basestock to impart lubricity, one or more surfactants having an inverse wetting profile and optionally alkaline materials, viscosity-modifiers and additional adjuvants.

Another object of the invention is to provide a process for forming and welding using a composition as described herein, wherein a lubricating anti-weld spatter lubricant composition is applied prior to forming and the formed part is subsequently welded, without removal of the composition prior to welding, and preferably without application of additional anti-weld spatter compositions after forming, such that the lubricating composition interferes with adherence of weld spatter.

In one embodiment, compositions according to the invention comprise a synthetic or semi-synthetic stamping lubricant that includes materials which will leave a post-stamping residue that functions as an AWS coating.

In one embodiment, a composition useful in processes of the invention comprises water, a polyalkylene glycol basestock, surfactants such as ethoxylated alcohols and alkylphenols, triethanolamine, a cellulose-based viscosity-modifier.

In another embodiment, the composition comprises water, a polyalkylene glycol basestock, surfactants such as ethoxylated alcohols and alkylphenols, triethanolamine, acrylic polymer viscosity-modifier and a defoamer.

One aspect of the invention is the multiple benefits derived at various points in the production process. In Applicant's process, the composition is applied prior to the forming step and not removed, hence saving a cleaning step after forming. The welding step is also benefited by receiving formed parts that already carry a pretreatment of anti-weld spatter compound. This provides the benefit of saving a second coating step, as well as limiting the liquid application to a single location as opposed to one before forming stations and one before welding stations. As shown in Table A, the process sequence is shortened at least two steps (33-50%), with the associated cost savings.

TABLE A

| | Conventional Process Steps | Applicant's Process Steps |
|---|---|---|
| 1 | Apply Forming Lubricant | Apply Anti-Weld Spatter |
| | | Lubricant |
| 2 | Form | Form |
| 3 | Clean (optional) | — |
| 4 | Apply Anti-Weld Spatter Material | — |
| 5 | Dewater Anti-Weld Spatter Material | — |
| 6 | Weld | Weld |

An object of the invention is to eliminate the need to apply anti-weld spatter material at the point of application of the weld, such as the body shop, thereby reducing the total number of process steps. This object also supports removal of AWS material spray stations, booths and machinery from the body shop and insures that all paintable parts are coated with AWS material. Also eliminated from the body shop is the dripping AWS material that finds its way around the entire body shop conveyor system. AWS material is very slippery and reducing floor contamination is desirable from a safety standpoint. A safety, health, and environmental benefit of the new material is the lack of AWS material drippings commonly found on the plant floor for up to 50 feet of line after the AWS spray stations.

Applicant's process also provides a surprising reduction in the amount of anti-weld spatter lubricant composition required to be applied prior to forming as compared to the amount for anti-weld spatter material required for conventional processes where an anti-weld spatter material is applied between the forming and welding steps. Conventionally, the amount of anti-weld spatter material applied after forming and prior to welding is typically on the order of about 50 g/m² or more. Heavier coatings of as much as 500 g/m² are often required where mill oil or other forming lubricant remains on the formed surfaces, which must be fully wetted by the anti-weld spatter material to ensure protection from weld spatter. In one embodiment of Applicant's process, a sufficient amount of dual purpose, anti-weld spatter lubricant applied prior to forming that still provides good performance is independently, in increasing order of preference, less than 50, 40, 30, 20, 19, 18, 17, 16, 15, 14, 13, 12, 11, 10 g/m² and independently, in increasing order of preference is at least 1, 2, 3, 4, 5, 6, 7, 8, 9 g/m²

In one embodiment, the invention relates to a method of making an article of manufacture comprising:
a) applying an anti-weld spatter lubricant composition to a metal substrate, and optionally drying the composition, to produce a coating on the metal substrate;
b) forming the coated metal substrate into a coated formed part;
c) welding together the coated formed part and a second weldable substrate to form a welded construction having weld spatter temporarily adhered to at least one surface of the coated formed part;
d) removing the weld spatter from the at least one surface of the coated formed part in the absence of grinding.

The removing step may comprise water rinsing, alkaline cleaning, acid cleaning, pickling, pre-phosphating conditioner, phosphating, and/or non-phosphate pre-treatment.

In another embodiment, the invention relates to a method of treating a metal substrate comprising:
a) applying an anti-weld spatter lubricant composition to a first metal substrate, optionally drying the composition, to produce a coating on the first metal substrate;
b) forming the first metal substrate such that at least a portion of the coating applied in step a) remains on the metal substrate;
c) welding together the first metal substrate and a second metal substrate to form a welded construction having weld spatter temporarily adhered to at least one surface of the first metal substrate; and
d) removing the weld spatter from the first metal substrate by at least one of water rinsing, alkaline cleaning, acid cleaning, pickling, pre-phosphating conditioner, phosphating, and non-phosphate pre-treatment.

The above-described methods are desirably in the absence of a step comprising removing the coating of step a) prior to welding and/or (preferably and) a step comprising applying an anti-weld spatter composition after forming. These methods may comprise at least one additional step of applying paint to the welded construction, such as by way of non-limiting example primer paint, anti-corrosion paint, colored paint, clearcoat paint, topcoat paint, autophoretically deposited paint, electrophoretically deposited paint, varnish, lacquer and the like.

Without being bound by a single theory, it is desirable that a layer of the coating separates the temporarily adhered weld spatter from immediately adjacent surfaces of the welded construction and or that the coating interferes with wetting of the at least one surface of the coated formed part by molten weld spatter contacting said surface.

Optionally the second weldable substrate also comprises the coating made by applying and optionally drying an anti-weld spatter lubricant composition as described herein.

The metal substrate and the second weldable substrate may be selected from the group consisting of steel, steel coated with one or more weldable non-ferrous metals, aluminum, aluminum alloy, zinc, zinc alloy, magnesium, magnesium alloy, titanium, and titanium alloy. The metal substrate and the second weldable metal substrate may comprise a combination of weldable metal substrates.

Processes for manufacturing any welded construction by welding two weldable substrates together after forming of at least one of the weldable substrates can benefit from incorporating the invention. Desirable welded constructions are those selected from a vehicle body, a marine vessel, an architectural structure or an aerospace structure. Other welded constructions suitable for using this process include welded constructions made on assembly lines, such as metal housing components, for example doors and windows; metal furniture, such as chairs and work surfaces; and recreational goods, for example playground equipment, recreational vehicles such as bicycles and the like.

Other than in the operating examples, or where otherwise indicated, all numbers expressing quantities of ingredients, reaction conditions, or defining ingredient parameters used herein are to be understood as modified in all instances by the term “about”. Unless otherwise indicated, all percentages are percent by weight.

Compositions according to the invention comprise, consist essentially of, or consist of:
a) water,
b) an organic basestock;
c) one or more surfactants having an inverse wetting profile;
d) and optionally alkaline materials, viscosity-modifiers and additional adjuvants.

Suitable base stocks imparting lubricity include mineral oils, fatty esters, polyalkylene glycols, and polyalphaolefins. The base stock materials may be rendered water-soluble or dispersible by the addition of surfactants to the composition. Examples of suitable base stocks for compositions according to the invention include polyethylene glycols, including PEG 400DAB and PEG 8000.

Suitable surfactants are chosen based on the properties they may impart to the finished product such as wetting, low foaming, high detergency, and stable emulsification. Desirably, one or more of the surfactants in compositions of the invention have an inverse wetting profile, that is, at elevated temperatures the surfactant provides less wetting of a solid substrate than at lower temperatures. The less wetting provided at elevated temperatures and greater wetting provided at reduced temperatures is considered, without being bound by a single theory, to provide dewetting of the molten or elevated temperature weld spatter when it contacts the AWS coated metal substrate. Desirably, the one or more surfactants is dewetting of the weld spatter at 60, 70, 80, 90, 100 or 120° C. Examples of surfactants suitable for use in compositions of the invention include ethoxylated alcohols and alkylphenols such as those sold under the trade names Triton®, Antarox®, Rhodasurf® and the like.

Adjuvants including alkaline materials such as triethanolamine, biocides, extreme pressure lubricants, viscosity-improving agents, secondary surfactants and defoamers may also be included in the composition. Examples of suitable viscosity-improving agents include cellulose based thickeners known in the art, such as Natrosol® 250HR, as well as certain polymers, such as by way of non-limiting example acrylic polymers and copolymers sold under the trade names Acusol®, Acumer®, Polyacryl™ and the like.

Each of the aforementioned components is considered suitable subject to the proviso that the component does not interfere with the performance of the composition as a forming lubricant and as an anti-weld spatter composition.

In one embodiment, a composition of the invention comprises a polyalkylene glycol base stock imparting lubricity, surfactants such as ethoxylated alcohols and/or alkylphenols for improved wetting and reduced surface tension, alkaline materials such as triethanolamine, a viscosity-improving agent, and water. In another embodiment, the composition also contains acrylic polymer for viscosity improvement and a defoamer.

The compositions according to the invention are made by simple mixing of the components at ambient temperature. In a process according to the invention, the described compositions are applied to a metal substrate, typically sheet metal, by any means known in the art, but desirably by dipping, spraying or flow-coating.

Suitable compositions for use in processes of the invention are selected based on criteria including but not limited to providing adequate lubrication during forming operations, providing corrosion protection to the metal substrate, being readily removable by alkaline or acidic cleaners, burning cleanly at welding temperatures, which are approximately the melting point of the base metal, interfering with permanent adherence of weld spatter to a metal substrate. Burning cleanly means that upon exposure to welding temperatures, the composition does not generate on the metal substrate residue that interferes with weld quality, including strength and appearance.

The metal substrate to be coated can be any weldable metal substrate or combination of weldable metal substrates, such as by way of non-limiting example steel, including steel coated with one or more other metals, aluminum, aluminum alloy, zinc, zinc alloy, magnesium, magnesium alloy, titanium, and titanium alloy. The compositions form a lubricating coating on the surface of the metal substrate. Desirably the lubricating coating is dried on the metal substrate. Alternatively, forming can be initiated while the coating is wet.

In a preferred embodiment, the coated metal substrate is subjected to a forming operation, such as for example stamping, thereby creating a formed part having the lubricating coating thereon. The coated, formed part is then welded to a second metal substrate to form a welded construction, such as a chassis, body or other assembly. It is desirable that between forming and welding steps, the lubricating coating is not removed nor is a second coating applied, however, one could supplement the lubricating coating with a second coating between forming and welding to improve anti-weld spatter performance. Desirably, all substrates to be welded have deposited thereon an anti-weld spatter coating in order to obtain the most benefit from the composition and process of the invention.

During welding, weld spatter may be generated and temporarily adhere to one or more coated metal substrates. Desirably, the lubricating coating, or a derivative thereof generated during forming and/or welding, is interposed between the formed metal sheet and the weld spatter for a period of time sufficient to prevent the weld spatter from wetting the metal surface. Also desirable is the presence of the coating or a derivative thereof remaining after welding, but removable by cleaning as hereinafter described.

The welded construction may be subjected to additional steps selected from one or more of water rinsing, wiping with a cloth or other non-abrading physical contacting, alkaline cleaning, acid cleaning, pickling, pre-phosphating conditioner, phosphating, and non-phosphate pre-treatment, wherein in at least one of said additional steps any temporarily adhered weld spatter is removed. Desirably, the additional steps do not comprise grinding, sanding or chiseling. The welded construction may then optionally be painted. In a preferred embodiment, locations of any temporarily adhered weld spatter do not result in a paint flaws or inclusions.

The practice of this invention may be further appreciated by consideration of the following, non-limiting, working examples.

### EXAMPLES

Aqueous compositions according to Examples 1 and 2 were made up by thoroughly mixing the ingredients recited in the tables below.

TABLE 1
Example 1

| Ingredients (g/l) | |
|---|---|
| Hydroxyethyl cellulose thickening agent | 2.4 |
| Triethanolamine 99% | 6.7 |
| Polyethylene glycol | 196.0 |
| Modified aliphatic polyether surfactant | 7.0 |
| Ethoxylated alcohol surfactant | 1.4 |

TABLE 2
Example 2

| Ingredients (g/l) | |
|---|---|
| Triethanolamine 99% | 6.4 |
| Granular polyethylene glycol | 135.0 |
| Defoamer | 0.5 |
| Polyethylene glycol | 55.0 |
| Modified aliphatic polyether surfactant | 10.0 |
| Acrylic polymer thickener | 8.0 |
| Ethoxylated alcohol surfactant | 2.0 |

Example 1 and 2 compositions have anti-weld spatter effectiveness. To determine whether such compositions could also satisfy the requirements for metal forming, Example 1 and DRAWCO® FB 27 MH, a commercially available lubricant for stamping metal parts, were applied to steel panels and the compositions dried on the panels. DRAWCO® FB 27 MH is used in applications requiring Class A surface certification for automotive bodies and was considered state-of-the art for metal stamping lubricants requiring excellent surface quality.

The conventional stamping lubricant DRAWCO® FB 27 MH was used in a drawing test comparing performance of Example 1, according to the invention. The testing apparatus used to assess drawing performance was the drawbench. The drawbench pulls a strip of steel through a drawing die under pressure. Average friction is calculated over the duration of the test. An output chart describes the friction force over the draw stroke.

To perform the test, a metal strip was coated with the test lubricant (one strip for DRAWCO'FB 27 MH and one strip for Example 1) and the metal strip was inserted into a clamp. The clamp was locked to insure the strip was pulled with full pulling force through the die. The normal or load force was set using a hydraulic piston. In this case, the normal load was 1000 pounds. The hydraulic drive of the tester was charged and the drive piston released. The strip was drawn through the die. During the drawing operation, the position of the drive piston was recorded using a linear variable differential transformer (also linear variable displacement transducer) (LVDT). The force required to draw the metal strip through the die was measured using a load cell between the piston and the strip clamp. This output was fed into a data acquisition system and processed to translate voltage into a force measurement. The draw force was logged over the length of the draw stroke.

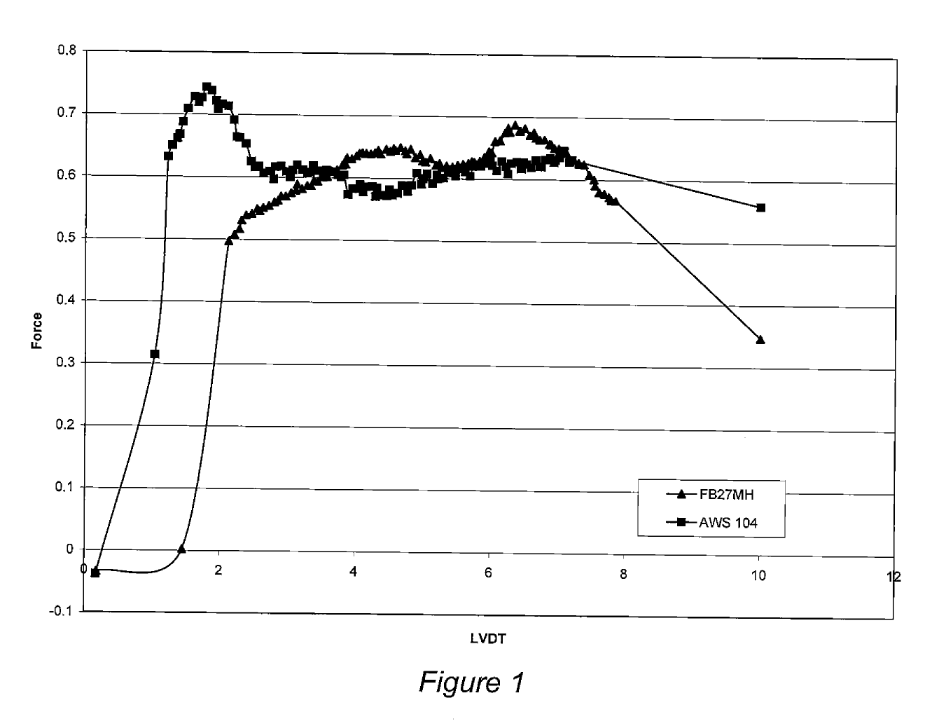

FIG. 1 shows a comparison of the friction force recorded over a draw stroke of a standard drawbench when using a conventional metal stamping lubricant (DRAWCO® FB 27 MH) as compared to Example 1 (AWS 104), a composition according to the invention, having anti-weld spatter properties. The units of force are y*2000 pounds (readout times 2000 pounds load). Distance units are x*2 cm (readout times 2 centimeters). Example 1 is useful as an anti-weld spatter composition, and as FIG. 1 shows, Example 1 is also suitable for stamping operations, where it produces forces on the metal substrate during drawing that are comparable to a known forming lubricant.

It is intended that the specification and examples be considered as exemplary only. Other embodiments of the invention, within the scope and spirit of the following claims will be apparent to those of skill in the art from practice of the invention disclosed herein and consideration of this specification. All documents referred to herein are incorporated by reference hereby.

1. A method of making an article of manufacture comprising:
a) applying an anti-weld spatter lubricant composition to a first weldable metal substrate, and optionally drying the composition, to produce a coated metal substrate;
b) forming the coated metal substrate into a coated formed part; and
c) welding together the coated formed part and a second weldable substrate to form a welded construction;
wherein substantially no anti-weld spatter compositions are applied between the forming and welding steps.

2. The method of claim 1 further comprising:
d) removing any temporarily adhered weld spatter from the welded construction in the absence of sanding, chiseling and/or grinding.

3. The method of claim 2 wherein the temporarily adhered weld spatter is removed by at least one of the following steps: wiping, rinsing, alkaline cleaning, acid cleaning, pickling, pre-phosphate conditioning, phosphating, and non-phosphate chemical pre-treating.

4. The method of claim 1 further comprising a step of selecting a dual purpose composition for use as the anti-weld spatter lubricant composition.

5. The method of claim 4 wherein the dual purpose composition is selected such that sufficient lubrication in step b) and sufficient interference with permanent adhesion of weld spatter in step c) is provided by said dual purpose composition.

6. The method of claim 1 wherein the anti-weld spatter lubricant composition and/or derivatives thereof generated in step b) remaining on said coated formed part interfere with permanent adhesion of weld spatter generated in step c).

7. The method of claim 1 wherein the second weldable substrate also comprises a coating according to step a).

8. The method of claim 1 wherein the anti-weld spatter lubricant composition is applied to the metal substrate in an amount of less than 20 g/m².

9. A method of treating a metal substrate comprising:
a) applying an anti-weld spatter lubricant composition to a first metal substrate, optionally drying the composition, to produce a coating on the first metal substrate;
b) forming the first metal substrate such that at least a portion of the coating applied in step a) remains on the metal substrate;
c) welding together the first metal substrate and a second metal substrate to form a welded construction having weld spatter temporarily adhered to at least one surface of the first metal substrate; and
d) removing the weld spatter from the first metal substrate by at least one of wiping, rinsing, alkaline cleaning, acid cleaning, pickling, pre-phosphating conditioner, phosphating, and non-phosphate chemical pre-treating.

10. The method of claim 9 further comprising a step of selecting a dual purpose composition for use as the anti-weld spatter lubricant composition.

11. The method of claim 10 wherein the dual purpose composition is selected such that sufficient lubrication in step b) and sufficient interference with permanent adhesion of weld spatter in step c) is provided by said dual purpose composition.

12. The method of claim 9 wherein the anti-weld spatter lubricant composition and/or derivatives thereof generated in step b) remaining on said coated formed part interfere with permanent adhesion of weld spatter generated in step c).

13. The method of claim 9 wherein the second weldable substrate also comprises a coating according to step a).

14. The method of claim 9 wherein the anti-weld spatter lubricant composition is applied to the metal substrate in an amount of at least 0.5 g/m² and less than 17 g/m².

15. An article of manufacture made according to claim 9.

16. An article of manufacture comprising a welded construction having at least one formed metal surface and a layer of anti-weld spatter lubricant composition on said formed metal surface, in direct contact therewith and in the absence of a forming lubricant layer interposed between said formed metal surface and the layer of anti-weld spatter lubricant composition.

17. The article of manufacture of claim 16 wherein the anti-weld spatter lubricant composition comprises:
a) an organic basestock comprising at least one of mineral oils, fatty esters, polyalkylene glycols, and polyalphaolefins;
b) one or more surfactants having an inverse wetting profile;
c) and optionally alkaline materials, viscosity-modifiers and additional adjuvants.

18. The article of manufacture of claim 16 wherein the anti-weld spatter lubricant composition comprises:
a) at least one polyalkylene glycol;
b) at least one surfactant having an inverse wetting profile;
c) at least one alkaline material; and
d) optionally, at least one of defoamers and thickeners.
